(19) United States
(12) Patent Application Publication
(10) Pub. No.: US 2025/0123092 A1
(43) Pub. Date: Apr. 17, 2025

(54) STEERING SENSOR ASSEMBLY AND STEERING SENSOR SYSTEM

(71) Applicant: DANA ITALIA S.R.L., Arco (IT)

(72) Inventors: Giovanni MARIECH, Arco (Trento) (IT); Mario BONORA, Arco (Trento) (IT); Alessandro STRAUSS, Arco (Trento) (IT)

(21) Appl. No.: 18/913,810

(22) Filed: Oct. 11, 2024

(30) Foreign Application Priority Data
Oct. 13, 2023 (DE) 20 2023 105 930.9

(51) Int. Cl. G01B 7/30; G01D 5/16; G01D 5/20

(52) U.S. Cl. CPC G01B 7/30; G01D 5/16; G01D 5/20

(57) ABSTRACT

The present disclosure relates to a steering sensor assembly for sensing a steering angle between a stationary component and a rotatable component rotatably mounted on the stationary component about a steering axis. The steering sensor assembly comprises a sensor at least partially fixed with respect to the steering axis, and a sensor counterpart movable about the steering axis. The sensor and the sensor counterpart are arranged distanced from the steering axis. The present disclosure further relates to a steering sensor system including said steering sensor assembly.

### CROSS REFERENCE TO RELATED APPLICATION

This application claims priority to German Utility Model Application No. 20 2023 105 930.9, entitled “STEERING SENSOR ASSEMBLY AND STEERING SENSOR SYSTEM”, filed Oct. 13, 2023. The entire contents of the above-identified application is hereby incorporated by reference for all purposes.

### TECHNICAL FIELD

The present disclosure relates to a steering sensor assembly and steering sensor system. For example, the steering sensor assembly may be provided for the steering sensor system. The subject-matter of the present disclosure may be used for vehicles, for example two-track motor vehicles.

### BACKGROUND AND SUMMARY

Steering sensors are typically used in automotive vehicles to determine the angle between a steering knuckle and a stationary portion of the vehicle such as an axle or axle housing. The sensor is typically installed at a steering end of the axle, coaxially with the steering axis. As state of the art, there are two main locations where to assemble the sensor, which is usually a hall-effect sensor provided at the kingpin location extending along the steering axis. First, the sensor may be installed on the rotating knuckle and a sensor counterpart, for instance a magnet, fixed to the stationary axle. This solution has the disadvantage that a sensor wiring necessary for connection of the sensor can freely rotate with the knuckle against the axle and is therefore subject to damage and excessive wear, which represents a problem due to potential loss of signal. Second, the sensor may be installed in a dedicated seat in the stationary axle with the sensor counterpart being connected on the top of the rotating knuckle. For protection, the wires are then placed in a specific channel within the axle thereby preventing wear and damage. However, this requires a more sophisticated casting, costing and/or assembly of the parts.

It is therefore an objective of this disclosure to provide an alternative and improved steering sensor assembly and steering sensor system. The improvement is particularly founded in the simplification of assembly and installation, and in the reduction of wear and tear.

This object is at least partially solved by a steering sensor assembly and a steering sensor system according to the present disclosure.

A steering sensor assembly for sensing a steering angle between a stationary component and a rotatable component rotatably mounted on the stationary component about a steering axis is proposed. The steering sensor assembly comprises a sensor at least partially fixed with respect to the steering axis and a sensor counterpart movable about the steering axis. The sensor and the sensor counterpart are arranged distanced from the steering axis.

The sensor assembly with the sensor and the sensor counterpart being off-centered to the steering axis may simplify the installation and/or reduce excessive wear. For example, the sensor assembly may be provided in a usually less functional area of the stationary and rotating component.

In general, the steering axis corresponds to the axis of rotation about which the rotating component is rotatable about the stationary component. An arrangement distanced from the steering axis relates to a radial distance measured orthogonally to the steering axis. The corresponding radial distance may comprise values of at least 1 cm, 5 cm or 10 cm and at most 5 cm, 10 cm or 30 cm. The sensor and the sensor counterpart may be arranged at the same radial distance from the steering axis. Alternatively, the sensor and the sensor counterpart may be arranged at different radial distances. However, they may be arranged together in one plane, for example a plane orthogonal to the steering axis.

The sensor and/or the sensor counterpart may at least partially extend circumferentially about the steering axis. Alternatively or additionally, the sensor counterpart may be movable circumferentially about the steering axis. For instance, the circumferential movement of the sensor counterpart may be coupled to the rotation of the rotatable component relative to the stationary component about the steering axis. A resulting area of movement and/or extent, also referred as sensing area, may cover a limited range, for example a central angle of not more than 225°, 180° or 120° and/or not less than 30°, 60° or 90°. The central angle of the sensing area may correspond to the maximum steering angle of the rotatable component relative to the stationary component. In other words, instead of having a full circular design, the sensor assembly may have a partial circular shape with an angular extension able to cover an entire steering stroke corresponding to the maximum steering angle. This may allow the assembly to be specifically adapted to the available installation space and/or the functionality of a steering sensor system. For example, this allows the sensor assembly to be installed in a nonfunctional area of a steering system that therefore can be exploited without the need of enlarging the overall system by means of dedicated areas/volumes. To limit the angular expansion of the steering sensor assembly, the position of any moving components, e. g. the sensor counterpart, may be in the middle of the fixed components, e. g. the sensor, when the steering angle is in the middle of the full steering travel, for instance, 0° when having a symmetrical steering angle. For instance, after installation, the steering sensor assembly may be calibrated to indicate 0° when the rotating component or, for instance, a wheel coupled to the rotating component is straight, i.e. orthogonal with respect to the stationary component.

The sensor and/or the sensor counterpart may comprise a sensor housing or sensor counterpart housing, respectively. For instance, the sensor and/or the sensor counterpart may comprise a housing circumferentially extending about the steering axis, for example within the sensing area. The sensor and the sensor counterpart may be in contact with each other or be arranged distanced from each other within a limited distance of not more than 0.1 mm, 0.5 mm or 1 mm. This can ensure the functionality of the arrangement and/or protect it from dirt ingress.

The sensor counterpart may be a wireless sensor counterpart. For example, the sensor counterpart may be a passive component, such as a magnet, without any need of electronics. In contrast, the sensor may be a wired sensor. In other words, the sensor may comprise active components wired or wireable to an external component such as a power source, a processing unit or the like. As such, only the sensor, which is fixed with regard to the stationary component, may include any external wiring thereby reducing any excessive wear of the assembly.

The sensor may be a resistance sensor, a capacitive sensor, a magnetic sensor or an optical sensor, for example an optical or magnetic encoder or a magnetic resolver. The sensors to be used can basically comprise known sensors, which are adapted to the present embodiments, for example with regard to the extension of the sensor and/or sensor counterpart arrangement within a limited sensing area and/or the relative arrangement of any stationary and moving parts.

For example, the sensor may be a resistance sensor, for example a potentiometer, with a variable effective electrical length. The effective electrical length may depend on a position of the sensor counterpart about the steering axis. A corresponding sensor setup can be designed in a particularly simple and adaptive way.

In this case, the sensor may comprise an electrically conductive sensor bridge movably coupled to the sensor counterpart, such that the effective electrical length is varied upon joint movement of the sensor bridge with the sensor counterpart. The sensor may comprise at least two electrically conductive rails circumferentially extending about the steering axis, for example within the sensing area. The sensor bridge may be movably guided on the conductive rails and short-circuit them with one another. In this case, the resistance, which is proportional to the effective electrical length of the conductive rails that in turn is linked to the steering angle, is determined by creating an electrical short cut between the conductive rails integrated in the sensor. The short cut may be determined by the sensor bridge connected to the rotating sensor counterpart, which may be rigidly fixed to the rotating component. The conductive rails may be connected or connectable to a power source. The sensor bridge and the sensor counterpart may be distanced from each other. Their distance may be limited to not more than 0.5 mm, 1 mm or 5 mm. The sensor bridge may be magnetically coupled to the sensor counterpart. For example, the sensor bridge may consist of or comprises a ferromagnetic material and/or a sensor magnet. The sensor counterpart may consist of or comprise a counter magnet magnetically coupled to the sensor bridge. The sensor may comprise a sensor housing enclosing the sensor bridge and/or the sensor rails. The sensor rails may be fixedly arranged inside the sensor housing. The sensor bridge may be movably arranged inside the housing. The sensor housing, the sensor rails and/or the power source may be rigidly fixed with respect to the steering axis. For instance, a counter magnet of the sensor counterpart fixedly attached to the rotating component may slide, in contact or with a limited air gap as previously described, against the external housing of the non-rotating sensor. A sensor bridge magnetically connected to the counter magnet, e. g. via a sensor magnet provided with the sensor bridge, may be positioned inside the sensor housing close to the sensor counterpart. A resulting small gap between the two magnets may ensure a free sliding of the parts with limited friction as well as ensure the magnetic connection of the sensor bridge and the sensor counterpart.

According to another example of the sensor assembly, the sensor may be a magnetic resolver. In this case, the sensor counterpart may comprise a magnetic band, for example a magnetic band extending within the sensing area. The sensor may be an electronic sensor and may, for example, comprise or consist of electrically conductive coils. In this case, a movement of the magnetic band, e. g. caused by the steering angle, may induce an alternate current in the coils with a phase proportional to the steering angle. The magnetic band may be accommodated in a housing of the sensor counterpart. The coils of the sensor may be accommodated in a sensor housing. The sensor housing and the sensor counterpart housing may be in contact with each other or be arranged distanced from each other within a limited distance of not more than 0.1 mm, 0.5 mm or 1 mm in order to assure a free sliding of the two parts while providing an electronic coupling capable of indicating a steering angle.

Furthermore, a steering sensor system is proposed. The steering sensor system comprises a stationary component, a rotatable component rotatably mounted on the stationary component about a steering axis, and a steering sensor assembly arranged radially distanced from the steering axis. The steering sensor assembly may be of the type as previously described. The radial distance may comprise values of at least 1 cm, 5 cm or 10 cm and at most 5 cm, 10 cm or 30 cm.

The sensor system with the sensor and the sensor counterpart being off-centered to the steering axis may simplify the installation and/or reduce excessive wear, for example since the sensor assembly may be provided in a usually less functional area of the stationary and rotating component.

The stationary component may be an axle. The rotatable component may be a knuckle rotatably mounted on the axle. For instance, the axle may relate to an axle or, more specific, an axle housing, of a steering axle of a two-track vehicle. The knuckle may be rotatably mounted on the axle via a kingpin, which kingpin extends along the steering axis.

The steering sensor assembly is arranged radially distanced from the kingpin. This allows the steering sensor assembly to be provided in a less functional area of the steering sensor system, further simplifying installation and further reducing stress and wear. The radial distance may comprise values of at least 1 cm, 5 cm or 10 cm and at most 5 cm, 10 cm or 30 cm.

The steering sensor assembly may comprise a sensor at least partially fixedly attached to the stationary component or axle, for example to an outside of the stationary component. For example, the sensor may comprise a sensor housing fixedly and rigidly attached to the stationary component. For example, with regard to the potentiometer arrangement as previously described, all the components of the sensor may be fixed with respect to the stationary component, except for the sensor bridge which may be movably or slidingly accommodated inside the sensor housing. A sensor counterpart of the steering sensor assembly may be fixedly attached to the rotatable component or knuckle, for example to an outside of the rotatable component. This may grant an easy installation method as well as good serviceability in case of damage of the sensor or the sensor counterpart without the need to remove other components. A respective connection may be provided by means of a screw connection. The sensor counterpart may be at least partially fixedly arranged in a pocket of the rotatable component. This allows the sensor counterpart to be better attached to the rotatable component and at the same time protected from external influences. The pocket may be provided as a boss extending from the rotatable component. For example, the knuckle may comprise a pocket or boss for at least partially accommodating the sensor counterpart. In the case of the potentiometer arrangement previously described, the sensor counterpart, such as a counter magnet, may be fully or partially enclosed within the pocket, with only a side of the pocket facing the sensor or sensor housing being open.

As already previously described, the sensor and/or the sensor counterpart may at least partially extend and/or the sensor counterpart may be movable circumferentially about the steering axis, optionally in a sensing area covering a central angle of not more than 225°, 180° or 120° and/or not less than 30°, 60° or 90° and/or covering a central angle corresponding to a maximum steering angle of the rotatable component relative to the stationary component.

Several embodiments have been disclosed herein. From the following detailed description, which shows and describes two exemplary embodiments of the present disclosure, further embodiments of the present disclosure and appropriate combinations of features will become apparent to the person skilled in the art. Accordingly, the figures and the detailed description are to be regarded as exemplary and not restrictive. Recurring features are marked with the same reference signs in the description of the accompanying figures.

### BRIEF DESCRIPTION OF THE FIGURES

FIG. 1 shows a perspective sectional view of a steering sensor system according to prior art.

FIG. 2 shows a schematic view of a steering sensor system with a steering sensor assembly according to an embodiment of the present disclosure.

FIG. 3 shows a first perspective view of the steering sensor system of FIG. 2.

FIG. 4 shows another perspective view of the steering sensor system of FIG. 2.

FIG. 5 shows a schematic view of an exemplary sensor layout.

FIG. 6 shows a schematic view of a steering sensor system with a steering sensor assembly according to another embodiment of the present disclosure.

FIG. 7 shows a first perspective view of the steering sensor system of FIG. 6.

FIG. 8 shows another perspective view of the steering sensor system of FIG. 6.

### DETAILED DESCRIPTION

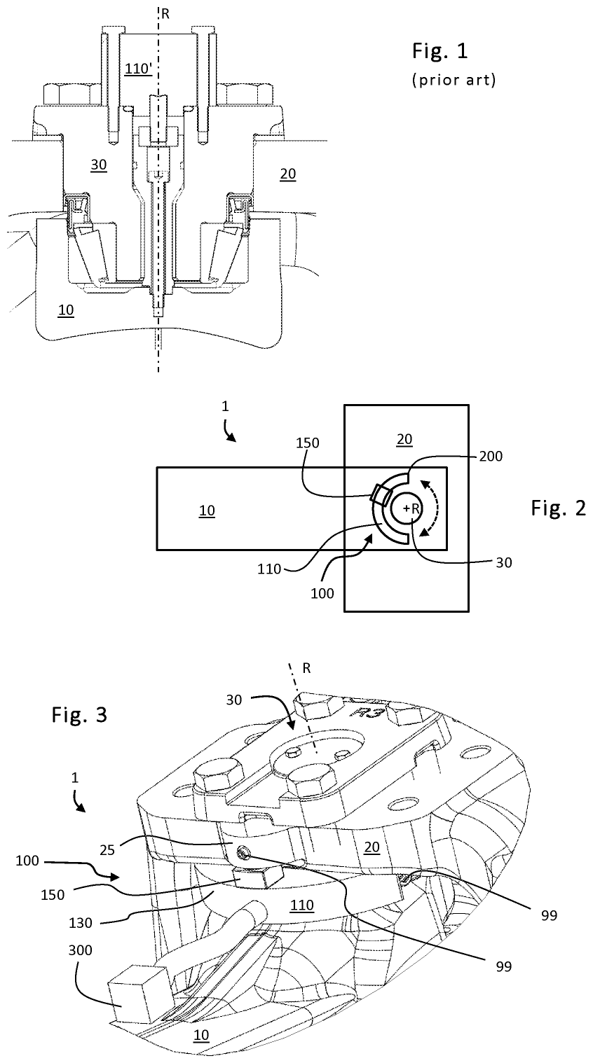

FIG. 1 shows a steering sensor system according to prior art. Therein, a sensor 110′ is mounted coaxially with a steering axis R and fixedly attached to a kingpin 30 extending along the steering axis R. The kingpin 30 is fixedly attached to a knuckle which is thereby rotatable about the steering axis R against an axle 10. The sensor 110′ is configured to measure a steering angle about the steering axis R of the knuckle relatively to the axle and has to be wired to a power source and a processing unit. Upon rotation of the knuckle relative to the axle about the steering axis R, the sensor 110′ rotates as well, thereby excessively wearing the wire. Furthermore, as the sensor 110′ is provided in a high-functional area of the steering sensor system arrangement, installation and maintenance may be difficult.

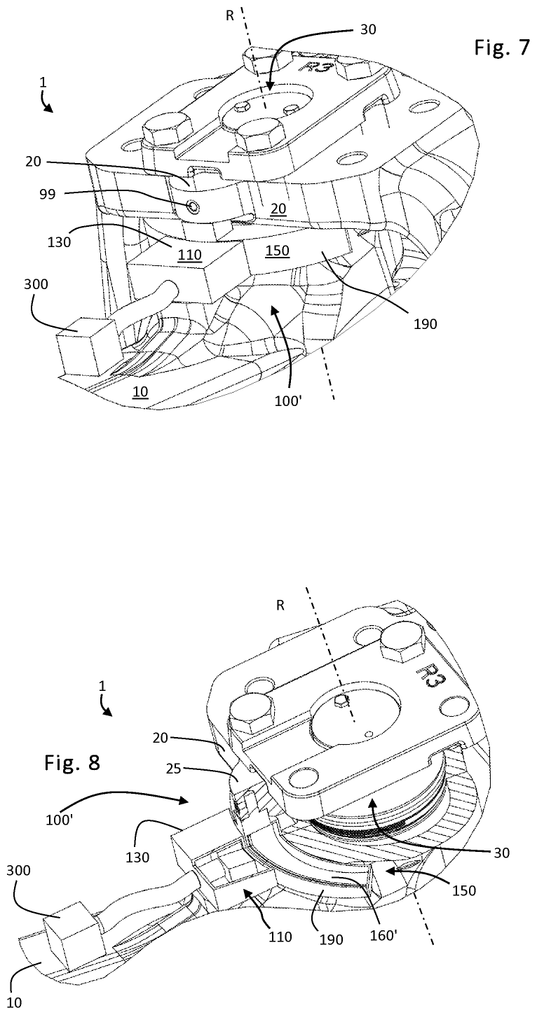

FIGS. 2, 3 and 4 relate to an exemplary steering sensor system 1 with a first exemplary embodiment of a steering sensor assembly 100, while FIGS. 6, 7 and 8 relate to a steering sensor system 1 with a second exemplary embodiment of a steering sensor assembly 100′. A more specific sensor layout is presented in FIG. 5, which layout may be provided with the first embodiment of the steering sensor assembly 100. In the following, recurring features are described once for all figures. Reference is only made to individual figures where this is appropriate or where differences or alternatives are to be identified.

The steering sensor system 1 comprises a stationary component 10, a rotatable component 20 rotatably mounted on the stationary component 10 about a steering axis R, and a steering sensor assembly arranged radially distanced from the steering axis R. For example, the steering sensor assembly 100, 100′ may be of the type as described in the following.

The steering sensor assembly 100, 100′ for sensing a steering angle between a stationary component 10 and a rotatable component 20 rotatably mounted on the stationary component 10 about a steering axis R comprises a sensor 110 at least partially fixed with respect to the steering axis R and a sensor counterpart 150 movable about the steering axis R. The sensor and the sensor counterpart are arranged distanced from the steering axis.

The radial distance may comprise values of at least 1 cm, 5 cm or 10 cm and at most 5 cm, 10 cm or 30 cm.

Here, the stationary component 10 is an axle, the rotatable component 20 is a knuckle rotatably mounted on the axle. For instance, the axle may relate to an axle or, more specific, an axle housing, of a steering axle of a two-track vehicle. The knuckle is rotatably mounted on the axle via a kingpin 30, which kingpin 30 extends along the steering axis R. The steering sensor assembly 100, 100′ is arranged radially distanced from the kingpin 30. The radial distance may comprise values of at least 1 cm, 5 cm or 10 cm and at most 5 cm, 10 cm or 30 cm.

According to the example of FIGS. 2-5, the sensor 110 and the sensor counterpart 150 are arranged at the same radial distance from the steering axis R. According to the example of FIGS. 6-8, the sensor 110 and the sensor counterpart 150 are arranged at different radial distances in one plane orthogonal to the steering axis R.

According to the example of FIGS. 2-5, the sensor 110 extends circumferentially about the steering axis R. According to the example of FIGS. 6-8, the sensor counterpart 150 extends circumferentially about the steering axis R. In both cases, the sensor counterpart 150 is movable circumferentially about the steering axis R. For example, the circumferential movement of the sensor counterpart 150 is coupled to the rotation of the rotatable component 20 relative to the stationary component 10 about the steering axis R. A resulting area of movement and/or extent, also referred as sensing area 200, covers a limited range. Here, the central angle is 180°. More general, the central angle may be not more than 225°, 180° or 120° and/or not less than 30°, 60° or 90°. The central angle of the sensing area 200 may correspond to the maximum steering angle of the rotatable component 20 relative to the stationary component 10. In other words, instead of having a full circular design, the sensor assembly 100, 100′ has a semicircular shape with an angular extension able to cover an entire steering stroke corresponding to the maximum steering angle. To limit the angular expansion of the steering sensor assembly 100, 100′, the position of any moving components, e. g. the sensor counterpart 150, is be in the middle of the fixed components, e. g. the sensor 110, when the steering angle is in the middle of the full steering travel, for instance, 0° when having a symmetrical steering angle. For instance, after installation, the steering sensor assembly 100, 100′ may be calibrated to indicate 0° when the rotating component 20 or, for instance, a wheel coupled to the rotating component 20 is straight, i.e. orthogonal with respect to the stationary component 10.

The sensor 110 comprises a sensor housing 130. According to the example of FIGS. 6-8, the sensor counterpart 150 comprises a sensor counterpart housing 190. The sensor housing 130 and the sensor counterpart housing 190 circumferentially extend about the steering axis R within the sensing area 200. The sensor 110 and the sensor counterpart 150 may be in contact with each other or be arranged distanced from each other within a limited distance of not more than 0.1 mm, 0.5 mm or 1 mm.

The sensor counterpart 150 is a wireless sensor counterpart. For example, the sensor counterpart 150 is a passive component, such as a magnet, without any need of electronics. In contrast, the sensor 110 is a wired sensor presently wired to a power source 300. The sensor may be a resistance sensor, a capacitive sensor, a magnetic sensor or an optical sensor, for example an optical or magnetic encoder or a magnetic resolver.

Referring to FIGS. 2-5, the sensor 110 is a resistance sensor, for example a potentiometer, with a variable effective electrical length. The effective electrical length depends on a position of the sensor counterpart 150 about the steering axis R.

According to this exemplary embodiment, the sensor 110 comprises an electrically conductive sensor bridge 120 movably coupled to the sensor counterpart 150, such that the effective electrical length is varied upon joint movement of the sensor bridge 120 with the sensor counterpart 150. The sensor 110 comprises two electrically conductive rails 121, 122 circumferentially extending about the steering axis R within the sensing area 200. The sensor bridge 120 is movably guided on the conductive rails 121, 122 and short-circuit them with one another. In this case, the resistance, which is proportional to the effective electrical length of the conductive rails 121, 122 that in turn is linked to the steering angle, is determined by creating an electrical short cut between the two conductive rails 121, 122 integrated in the sensor 110. The short cut is determined by the sensor bridge 120 connected to the rotating sensor counterpart 150, which is rigidly fixed to the rotating component 20. The conductive rails 121, 122 are connected to the power source 300. The sensor bridge 120 and the sensor counterpart 150 are arranged distanced from each other. Their distance may be limited to not more than 0.5 mm, 1 mm or 5 mm. The sensor bridge 120 is magnetically coupled to the sensor counterpart 150. The sensor bridge 120 may consist of or comprises a ferromagnetic material and/or a sensor magnet. The sensor counterpart 150 may consist of or comprise a counter magnet magnetically coupled to the sensor bridge 120. Here, the sensor counterpart 150 is a counter magnet 160. The sensor housing 130 encloses the sensor bridge 120 and the sensor rails 121, 122. The sensor rails 121, 122 are fixedly arranged inside the sensor housing 130. The sensor bridge 120 is movably arranged inside the housing 130. The sensor housing 130, the sensor rails 121, 122 and the power source 300 are rigidly fixed with respect to the steering axis R, i. e. with respect to the stationary component 10 or axle. The counter magnet 160 of the sensor counterpart 150 is fixedly attached to the rotating component 20 or knuckle and may slide, in contact or with a limited air gap as previously described, against the external sensor housing 130 of the non-rotating sensor 110. The sensor bridge 120 magnetically connected to the counter magnet 160, e. g. via a sensor magnet provided with the sensor bridge 120, is positioned inside the sensor housing 130 close to the sensor counterpart 150.

According to the second example of the sensor assembly 100′ as shown in FIGS. 6-8, the sensor 110 is a magnetic resolver. In this case, the sensor counterpart 150 comprises a magnetic band 160′ extending within the sensing area 200. The sensor 110 is an electronic sensor and comprises electrically conductive coils. The magnetic band 160 is accommodated in a sensor counterpart housing 190. The coils of the sensor 110 are accommodated in the sensor housing 130. The sensor housing 130 and the sensor counterpart housing 190 may be in contact with each other or be arranged distanced from each other within a limited distance of not more than 0.1 mm, 0.5 mm or 1 mm.

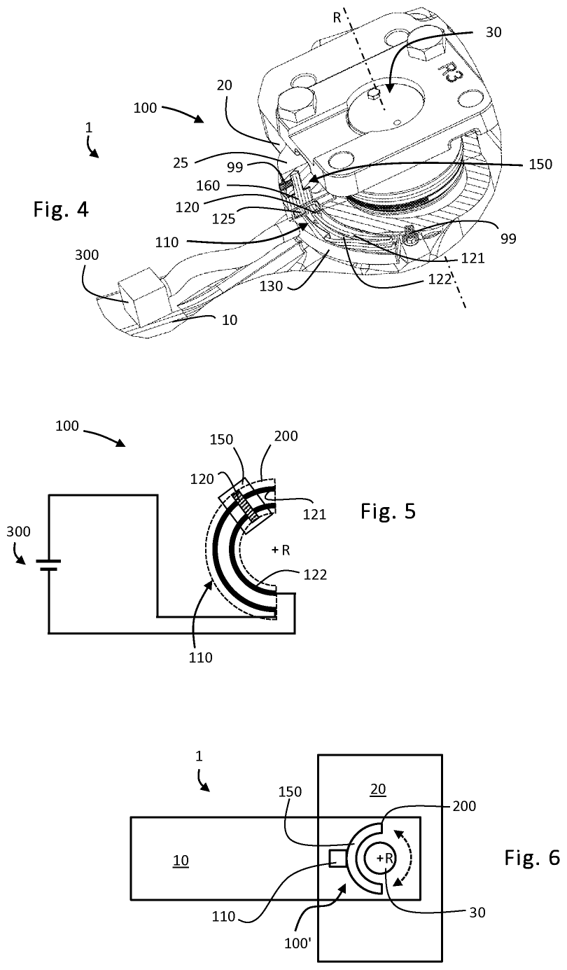

As previously described, the steering sensor assembly 100, 100′ comprises a sensor 110 at least partially fixedly attached to the stationary component 10 or axle, for example to an outside of the stationary component 10. For example the sensor 110 comprises a sensor housing 130 fixedly and rigidly attached to the stationary component 10. For example, with regard to the potentiometer arrangement as previously described, all the components of the sensor 110 are fixed with respect to the stationary component 10, except for the sensor bridge 120 which is movably or slidingly accommodated inside the sensor housing 130. the sensor counterpart 150 of the steering sensor assembly 100, 100′ is fixedly attached to the rotatable component 20 or knuckle, for example to an outside of the rotatable component 20. A respective connection to the stationary component 10 or the rotatable component 20 is provided by means of a screw connection 99. The sensor counterpart 150 is at least partially fixedly arranged in a pocket 25 of the rotatable component 20 or knuckle. The pocket 25 is provided as a boss extending from the rotatable component 20. In the case of the potentiometer arrangement previously described, see FIGS. 3 and 4, the sensor counterpart 150 and for example the counter magnet 160 partially enclosed within the pocket 25, with the side of the pocket 25 facing the sensor 110 or sensor housing 130 being open.

### LIST OF REFERENCE SIGNS

1 steering sensor system
10 stationary component
20 rotating component
25 pocket
30 kingpin
R steering axis
99 screw connection
100, 100′ steering sensor assembly
110 sensor
120 sensor bridge
121, 122 sensor rails
125 sensor magnet
130 sensor housing
150 sensor counterpart
160, 160′ counter magnet
190 sensor counterpart housing
200 sensing area
300 power source

1. A steering sensor assembly for sensing a steering angle between a stationary component and a rotatable component rotatably mounted on the stationary component about a steering axis, the steering sensor assembly comprising:
a sensor at least partially fixed with respect to the steering axis and a sensor counterpart movable about the steering axis, wherein the sensor and the sensor counterpart are arranged distanced from the steering axis.

2. The steering sensor assembly of claim 1, wherein the sensor and/or the sensor counterpart at least partially extends and/or the sensor counterpart is movable circumferentially about the steering axis in a sensing area covering a central angle of not more than 225° and/or not less than 30° and/or corresponding to a maximum steering angle of the rotatable component relative to the stationary component.

3. The steering sensor assembly of claim 1, wherein the sensor counterpart is a wireless sensor counterpart and/or the sensor is a wired sensor being wired or wireable to a power source.

4. The steering sensor assembly of claim 1, wherein the sensor is a resistance sensor, a capacitive sensor, a magnetic sensor or an optical sensor.

5. The steering sensor assembly of claim 1, wherein the sensor is a resistance sensor with a variable effective electrical length, which effective electrical length depends on a position of the sensor counterpart about the steering axis.

6. The steering sensor assembly of claim 5, wherein the sensor comprises an electrically conductive sensor bridge movably coupled to the sensor counterpart, such that the variable effective electrical length is varied upon joint movement of the electrically conductive sensor bridge with the sensor counterpart.

7. The steering sensor assembly of claim 6, wherein the sensor comprises at least two electrically conductive rails circumferentially extending about the steering axis within a sensing area, and wherein the electrically conductive sensor bridge is movably guided on the at least two electrically conductive rails and short-circuits the at least two electrically conductive rails.

8. The steering sensor assembly of claim 7, wherein the at least two electrically conductive rails are connected or connectable to a power source.

9. The steering sensor assembly of claim 6, wherein the electrically conductive sensor bridge and the sensor counterpart are distanced from each other and/or wherein the electrically conductive sensor bridge is magnetically coupled to the sensor counterpart.

10. The steering sensor assembly of claim 9, wherein the electrically conductive sensor bridge consists of or comprises a ferromagnetic material and/or a sensor magnet and/or wherein the sensor counterpart consists of or comprises a counter magnet magnetically coupled to the electrically conductive sensor bridge.

11. The steering sensor assembly of claim 7, wherein the sensor comprises a sensor housing enclosing the electrically conductive sensor bridge and/or the at least two electrically conductive rails.

12. The steering sensor assembly of claim 11, wherein the at least two electrically conductive rails are fixedly arranged inside the sensor housing and/or the electrically conductive sensor bridge is movably arranged inside the sensor housing.

13. The steering sensor assembly of claim 11, wherein the sensor housing and/or the at least two electrically conductive rails and/or a power source are rigidly fixed with respect to the steering axis.

14. A steering sensor system, comprising:
a stationary component,
a rotatable component rotatably mounted on the stationary component about a steering axis, and
a steering sensor assembly for sensing a steering angle between the stationary component and the rotatable component rotatably mounted on the stationary component about the steering axis, the steering sensor assembly comprising:
a sensor at least partially fixed with respect to the steering axis and
a sensor counterpart movable about the steering axis,
wherein the sensor and the sensor counterpart are arranged radially distanced from the steering axis.

15. The steering sensor system of claim 14, wherein the stationary component is an axle, the rotatable component is a knuckle rotatably mounted on the axle.

16. The steering sensor system of claim 15, wherein the knuckle is rotatably mounted on the axle via a kingpin, which kingpin extends along the steering axis.

17. The steering sensor system of claim 16, wherein the steering sensor assembly is arranged radially distanced from the kingpin.

18. The steering sensor system of claim 14, wherein the sensor is at least partially fixedly attached to the stationary component, and the sensor counterpart is fixedly attached to the rotatable component.

19. The steering sensor system of claim 18, wherein the sensor counterpart is at least partially fixedly arranged in a pocket of the rotatable component.

20. The steering sensor system of claim 18, wherein the sensor and/or the sensor counterpart at least partially extends and/or the sensor counterpart is movable circumferentially about the steering axis in a sensing area covering a central angle of not more than 225° and/or not less than 30° and/or corresponding to a maximum steering angle of the rotatable component relative to the stationary component.
